(19) United States
(12) Patent Application Publication
(10) Pub. No.: US 2007/0058246 A1
(43) Pub. Date: Mar. 15, 2007

(54) Microscope arrangement

(76) Inventors: Peter Westphal, Jena (DE); Martin Kuehner, Bad Klosterlausnitz (DE); Tobias Neumann, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/552,557

(22) PCT Filed: Mar. 25, 2004
(86) PCT No.: PCT/EP04/03156

§ 371 Date: Oct. 11, 2005

(30) Foreign Application Priority Data
Apr. 11, 2003 (DE) 103 17 615.2

(51) Int. Cl. G02B 21/00

(52) U.S. Cl. 359/368

(57) ABSTRACT

The invention relates to a microscope arrangement which comprises an illumination source (1), optical components for generating an illumination beam path, an objective [lens] (21) through which the illumination beam path is directed onto a sample (20) which is present in the object plane of the objective [lens] (21) or in the proximity thereof, and optical components for generating an imaging beam path directed onto the receiving surface of a camera (22). According to the invention, the microscope arrangement of the aforementioned type is provided with a homogenizing unit (5) for homogenizing the illumination light that is incident on the sample section to be examined. Said homogenizing unit (5) makes it possible to illuminate the object plane of the microscope arrangement and thus the subsection of a sample (20) present in the object plane or in the proximity thereof in a homogeneous manner, thereby improving the quality of reproduction of said sample section and resulting in a higher measuring accuracy and thus in a higher reproducibility.

### SCOPE OF THE INVENTION

The invention relates to a microscope arrangement which comprises an illumination source, optical components for generating an illumination beam path, a lens through which the illumination beam path is directed onto a sample which is present in the object plane of the lens or in the proximity thereof, and optical components for generating an imaging beam path directed onto the receiving surface of a camera.

### PRIOR ART

Microscope arrangements, especially for reflected light microscopy in connection with radiometric measurements on the surface of biochips, are known in the art. Such arrangements are essentially based on two different operating principles.

Thus, for example, laser scanning microscopes are know in which only a small surface of a few μm² of the sample is illuminated and, as a result, only the same small surface can be analyzed at the moment of illumination. To suppress false light during the evaluation and increase the image quality, “confocal” scanning methods are used, in that apertures are placed in the microscope beam path.

A disadvantage of laser scanning microscopy, especially during biochip analyses, is the risk of bleaching as a result of the high intensity of the laser beam focused on the small surface being viewed. Moreover, the selection of the wavelength of the illumination light is highly restricted. Furthermore, laser scanners require mechanically moved components, such as galvanic scanning devices, which results in relatively high mechanical wear as well as a high cost of adjustment. Another disadvantage is the low quantal efficiency of the detector, generally designed as a photo-multiplier, especially affecting illumination light with wavelengths above 600 nm.

Another principle is based on wide field detection. In this regard, a field having a larger surface area is illuminated on the sample and, using a lens and, if necessary, additional lenses, a corresponding segment of the sample is reproduced on a locally resolving receiver, such as a CCD camera.

If the analyses in question are fluorescent microscopic analyses, spectral filters, which are permeable for light of the respective wavelength, are placed in the illumination and/or excitation beam path and in the detection and/or fluorescence beam path.

Disadvantageously, the quality from image to image within an image sequence of a sample surface recorded using one of the microscope arrangements known in the art, which employs a camera, is not sufficiently uniform, thereby resulting in a tile-like structure in the overall image when several camera images are joined together. However, this joining together of images is indispensable, especially for reading biochips, whereas it is absolutely critical that the tile-like structure be avoided to achieve a precise evaluation.

Another disadvantage is that the uniformity of illumination of the object field and/or of the sample segment to be imaged is insufficient for highly precise analyses and, moreover, that the limited serviceable life of the illumination sources and/or maintenance thereof and the need for repeated adjustments prevents continuous evaluation of changing samples, as is necessary, for example, during the high-turnover measurement of biochips.

Another source of interference is unwanted reflection in the illumination and image beam path.

### DESCRIPTION OF THE INVENTION

Based on the aforementioned, the goal of the invention is to further develop a microscope arrangement operating in accordance with the principle of wide field detection such that measuring results are achieved with a higher degree of accuracy than is possible in the prior art.

According to the invention, the microscope arrangement of the aforementioned type is provided with a homogenizing unit for homogenizing the intensity of the illumination light that is incident on the sample section to be examined.

The use of said homogenizing unit advantageously results in the lens plane of the microscope arrangement and with it the section of a sample located in the lens plane or in proximity thereof being homogeneously illuminated and, as a result, an improved quality of the image of this sample section being achieved, which ultimately results in a higher quantitative measuring accuracy of intensity values to be determined.

Possible illumination sources are halogen lamps, arc lamps, LEDs and lasers, which emit light in the visible, the UV and/or the IR spectral range.

The homogenizing unit is advantageously formed as a fiber-optic waveguide, which comprises a receiving surface facing the illumination source and a emitting surface facing away from the lens. In this regard, the fiber-optic waveguide can be designed as an internally reflective hollow rod, as an internally totally reflective, transparent solid rod, as a liquid fiber-optic waveguide or in the form of a bundle of glass fibers.

If the fiber-optic waveguide consists of a bundle of glass fibers, it is recommended that the emitting surface itself be designed as a light dispersion disk, or that a light dispersion disk be disposed downstream from the emitting surface, and the light dispersion disk be imaged unclearly in the object plan, thereby homogenizing the illumination.

The optically active cross-section of the fiber-optic waveguide can be formed to be circular, square or rectangular. Moreover, the fiber-optic waveguide can be formed in such a way that the receiving surface, the emitting surface or both of these surfaces are provided with a micro-lens structure, a plurality of round, square, honeycomb-shaped or cylindrical micro-lenses are disposed adjacent to one another on the respective surface, and each of these lenses has a line radius of approximately 100 μm to 1000 μm perpendicular to the optical axis of the illumination beam path.

The homogenization of the beam intensity is achieved by conducting the light inside the fiber-optic waveguide by means of reflection, so that the light is mixed as a result of the multiple reflection of individual beam components on the highly-reflective interior wall. This results in a homogenization of beam intensity relative to the beam cross-section along the entire light path in the fiber-optic waveguide.

If the receiving and/or emitting surface is also equipped with a micro-lens structure, the illumination light, upon passing through this structure, is split into a number of partial beams corresponding to the plurality of the micro-lenses, resulting in even better mixing and/or homogenization of the intensity distribution.

In this regard, it is not necessary that the microstructure be disposed on the receiving and/or emitting surface, as shown in the example; instead, it is conceivable, and results in comparably favorable results, that the micro-lens structure be disposed on separate optical elements, said elements being arranged upstream from the receiving surface and/or downstream from the emitting surface.

It also lies within the scope of the invention to achieve homogenization by means of crossed micro-cylinder lenses, two optical elements disposed sequentially in the illumination beam path being structured with micro-cylinder lenses whose longitudinal directions are oriented to be perpendicular to the optical axis of the illumination beam path, wherein, however, the longitudinal direction of the micro-cylinder lenses on one element and the longitudinal direction of the micro-cylinder lenses on the other element enclose an angle of 90°.

To make the homogenized illumination beam useable for imaging the sample, means of imaging the emitting surface of the homogenization arrangement in the field aperture plane of the microscope arrangement are provided, as well as means of imaging the field aperture plane in the lens plane. As a result, the illumination light homogenized on the emitting surface enters the lens plane with homogenized intensity distribution.

In a simplified embodiment, the emitting surface of the homogenization unit is not imaged in the field aperture plane, but directly in the field aperture plane and/or in its immediate proximity. As a result, a reduction in the number of optical components is possible.

In another preferred embodiment of the invention, it is provided that the optically active surface of a field aperture disposed in the field aperture plane is structured to be strip-like or chessboard-like, wherein transparent and non-transparent partial surfaces alternate in the structure. In this case, a shutter for partially blocking the light is disposed directly in front of the field aperture. The shutter is preferably controllable and is used to darken selected surface sections of the field aperture. This results, in particular, in an autofocus sensor, if present, not being irradiated by the dispersed excitation light.

A field aperture structured in this manner is produced, for example, in that the desired strip-like or chessboard-like structure is initially vacuum metallized onto a glass plate and a second glass plate is then glued onto this structure. The two contact surfaces of the glass plates oriented toward the exterior and the air are preferably lumenized.

In another preferred embodiment of the microscope arrangement according to the invention, a first, partially permeable diversion mirror is disposed downstream from the field aperture in the illumination beam path, of which the predominant portion of the illumination light is guided through an illumination tube that parallelizes the illumination beam path and subsequently, depending on the application, through a spectral filter for selection of a spectral component intended for excitation on a color splitter, such as a dichroitic mirror, or contacts a partially permeable mirror and is guided by its splitter surface through the lens and onto the sample.

A smaller section of the illumination beam path diverted through the partially transparent diversion mirror disposed on the illumination tube can, for example, be directed onto a monitor detector, which serves to monitor the intensity of the illumination light. The output signal of the monitor detector can then be used for subsequent regulating or standardization of the intensity.

From the sample, the reflected or, in the case of fluorescence microscopy, emitted light passes through the lens again, then passes through the color splitter and/or the partially permeable mirror, as well as a second spectral filter disposed downstream, which is permeable for the emission and/or reflection light, and then reaches the camera through an imaging tube.

The illumination tube and the imaging tube are preferably formed from identical optical components, thereby minimizing production costs. It is also possible to provide the microscope arrangement with a defined optical interface for coupling the lens with the illumination as well as the imaging tube. This is advantageous because different lenses can be exchanged easily with little adjustment effort and, depending on choice, lenses can be used that either permit a high optical resolution of less than 1 μm or illuminate a large object field with a diameter of up to a few centimeters.

For this purpose, at least two lenses, which differ with respect to their optical properties, are disposed on a changing device, preferably a lens revolver.

It is also provided that a removable equalizing glass be disposed in front of the lens and/or lenses, as a result of which measurements of the sample can be taken with the equalizing glass, on an air/solid object contact surface facing the lens or, without the equalizing glass, through a transparent sample carrier.

It is also advantageous provided that the planar normals of the spectral filters in the illumination and/or the emission beam path and the optical axis of the respective beam path enclose an angle in the range of 1° to 20°, preferably 5°. This slope against the respective optical axis prevents false light from being analyzed, the slope of the spectral filter in the illumination beam path being especially significant with respect to an autofocusing device, as will be explained in detail below.

It is advantageous provided that the spectral filter in the illumination beam path and the spectral filter in the emission beam path, together with the color splitter, be structured as a filter cube. In a supplementary embodiment, this filter cube can be disposed with at least one additional filter cube, which differs from the first filter cube with respect to the filter wavelengths or, in fluorescence microscopy, for example, with respect to the excitation and emission wavelengths, on a changing device structured, for example, as a change wheel.

It also lies within the scope of the invention that a grayscale filter can pivot in the illumination beam path against the optical axis of the illumination beam path, wherein the planar normal of the grayscale filter and the optical axis of the illumination beam path enclose an angle in the range of 5° to 15°. This grayscale filter serves to weaken the beam wherein the incline of the filter against the optical axis prevents too much illumination light being reflected back to the illumination source by the receiving surface of the grayscale filter, thus avoiding inadmissible heating of the illumination source.

Especially advantageous is an embodiment in which the illumination source is connected to the remaining components of the microscope arrangement by a detachable mechanical connection. Because the illumination source, as a result of the homogenization unit, is decoupled from the remaining optical components that produce the illumination beam path, and the uniform intensity distribution in the illumination beam path achieved with the homogenization unit is also maintained when the illumination source is changed, the technical basis is provided for exchanging different illumination sources without requiring adjustment.

In this regard, the exchanged illumination sources differ with respect to both the technical configuration (halogen lamp, arc lamp, LED, etc.) and the wavelengths of the irradiated light (VIS, UV, IR).

Another embodiment option consists in arranging the lens to be displaceable on a slide bar in the direction of its optical axis and, for this purpose, to couple it with a motor-driven adjustment device. The capacity to displace the lens in the direction of the optical axis can be used to change the distance between the sample and the lens and, therefore, for focusing.

As an option, an autofocusing device is provided that encompasses an autofocusser, an autofocus actuating mechanism as well as means of bundling an autofocus laser beam in the illumination beam path.

The camera can be optionally configured as a CCD or CMOS camera.

In an especially preferred embodiment of the microscope arrangement according to the invention, the optical axis of the lens is oriented to be perpendicular to the direction of gravity. As a result, air bubbles, which frequently adhere to glass/fluid interfaces of cartridge-like samples, can accumulate above the fluid level, so that they no longer falsify the image, resulting in a higher measuring accuracy.

A sample table adjustable in coordinate directions X and/or Y perpendicular to the optical axis of the lens is provided to support the sample. The sample table can be advantageously coupled to a piezo drive and/or a spindle drive. The piezo drive is preferably provided for adjustment of the sample table in coordinate direction X and the spindle drive for adjustment of the sample table in coordinate direction Y, which preferably corresponds to the direction of gravity.

The sample table can also be provided with a leveling device, which is used to adjust the incline of the sample surface relative to the optical axis of the lens. The sample is arranged on the sample table by means of a sample holder, the sample holder and the sample table being detachably connected to one another.

### BRIEF DESCRIPTION OF THE DRAWINGS

The invention is described below in greater detail on the basis of exemplary embodiments. In the corresponding drawings:

FIG. 1 shows the basic principle of the invention on the basis of a microscope arrangement for fluorescence microscopy, the homogenization unit being formed as a solid glass tube,

FIG. 2 shows the basic principle of the microscope arrangement according to the invention, in which the homogenization unit is flexibly formed as a bundle of glass fibers,

FIG. 3 shows the basic principle of the microscope arrangement according to the invention, in which the homogenization unit comprises two optical elements,

FIG. 4 shows an autofocusing device integrated into the microscope arrangement according to the invention,

FIG. 5 shows the principle of the autofocus actuator within the microscope arrangement according to the invention,

FIG. 6 shows an embodiment variant of the microscope arrangement according to the invention, which is especially advantageous with regard to autofocusing,

FIG. 7 shows the incline of the planar normals of a spectral filter against the optical axis of the emission beam path,

FIG. 8 shows the coupling of the sample table to a drive device,

FIG. 8a shows the drive device for a sample table, which is adjustable in coordinate directions X and Y perpendicular to the optical axis of the lens, the optical axis of the lens being oriented perpendicularly to the direction of gravity,

FIG. 8b shows a view of the sample in direction A in FIG. 8a,

FIG. 9 shows the orientation of a cartridge-like sample, which has a reservoir for a fluid, in the microscope arrangement according to the invention.

### EXTENSIVE DESCRIPTION OF THE DRAWINGS

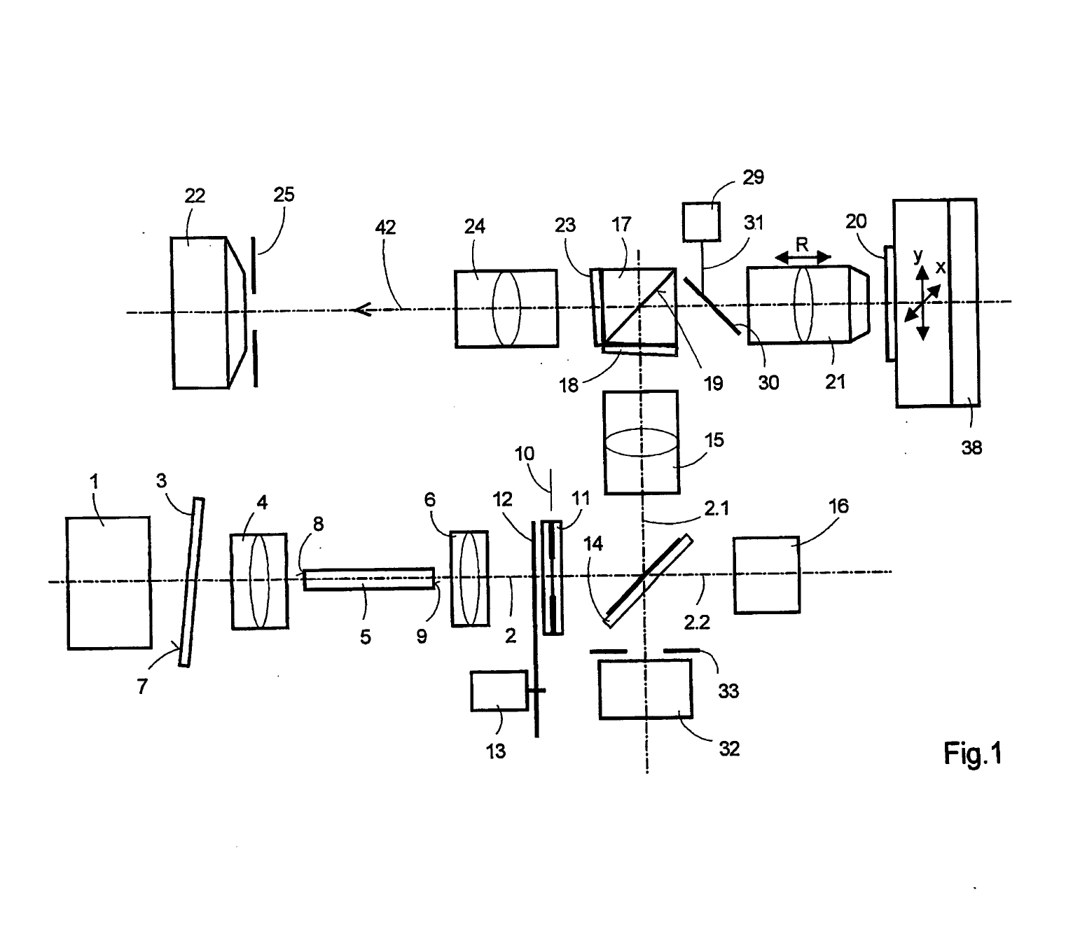

FIG. 1 shows the basic principle of the invention on the basis of a microscope arrangement for fluorescence microscopy.

In this regard, an illumination source is provided that emits light in the visible, in the UV and/or in the IR spectral range, for example. In special embodiments, the illumination source 1 can comprise a plurality of separately controllable beam sources that emit light in different wavelength ranges.

To form an illumination beam path along the optical axis 2, a grayscale filter 3, a first optical component 4, a homogenization unit 5 and a second optical component 6 are arranged downstream from the illumination source 1.

As indicated in the drawing, the normal on the incident light surface 7 of the grayscale filter and the optical axis 2 of the illumination beam path enclose an angle in the range of 5° to 15°, preferably 5°, so that the portion of the illumination light reflected by the incident light surface 7 is not re-reflected or is only re-reflected to a small degree into itself and/or to the illumination source 1, thereby preventing the illumination source I from becoming overheated.

The grayscale filter 3 itself serves to weaken the illumination beam and is advantageously arranged on a pivoting device, which makes it possible to pivot the grayscale filter 3 into or out of the illumination beam path as needed. The pivoting device is not shown in the drawing.

As an option, it can also be provided that several grayscale filters 3, which, as a result of different transparency, are capable of more or less weaken the illumination light, be placed on a change wheel, making it possible, depending on the desiring degree of weakening, to place one of these filters in the illumination beam path. The change device is not shown in the drawing, although its mode of construction is known in the art.

In the exemplary embodiment shown in FIG. 1, the homogenization unit 5 is executed as a totally reflecting, transparent solid glass rod with a rectangular cross-section.

The homogenization unit 5 has a receiving surface 8 and a emitting surface 9. The light entering the homogenization unit 5 through the receiving surface 8 is totally reflected inward several times as it passes through the homogenization unit 5, which leads to a mixing of individual beam components and results in the illumination light emerging from the emitting surface 9 with the essentially uniformly distributed intensity.

Instead of the solid rod, an internally reflective hollow rod can be provided, with normal reflection on the mirrored inner surfaces occurring instead of total reflection.

The purpose of the first optical component 4 is to focus the light coming from the illumination source 1 onto the receiving surface 8 with as little loss as possible. The purpose of the second optical component 6 is to reproduce the homogeneously illuminating emitting surface 9 in the field aperture plane 10 of the microscope arrangement.

In the field aperture plane 10 there is a field aperture 11, which, with the help of transparent and non-transparent surface segments, allows for illumination of the object field at high contrast. A shutter 12, which serves to darken selected sections of the field aperture 11, depending on the drive, is arranged directly in front of the field aperture 11. This prevents over-saturation of the autofocus sensor 32 with too much excitation light reflected by the sample 20.

The shutter 12 is driven by a rotation motor 13, which makes it possible to introduce various shutter settings in the illumination beam path, making it possible to effectively prevent the over-saturation of the autofocus sensor 32 with too much excitation light reflected by the sample 20.

Downstream from the field aperture 11 is a partially transparent diversion mirror 14, through which a predominant beam fraction 2.1 of the illumination beam path is guided in the direction of an illumination tube 15. A smaller beam fraction 2.2 of the illumination beam path passes through the partially transparent diversion mirror 15 and contacts a monitor detector 16, which monitors the intensity of the illumination light.

The monitor detector 16 can be connected with a display device for the beam intensity and/or, through an evaluation switch, with a resetting device for modifying the beam intensity, wherein the beam intensity of the light emitted by the illumination source 1 can, for example, be manipulated by means of the operating voltage. The feedback of the signal output of the monitor detector 16 to the illumination source 1 is not shown in the drawing, but can be performed in a manner known from control engineering.

While passing through the illumination tube 15, the beam fraction 2.1 is parallelized and then contacts a downstream filter cube 17. The filter cube 17 is provided, on its input end, with a first spectral filter 18, which ensures that only illumination light with wavelengths intended for excitation of a sample 20 reaches the beam splitter 19 of the filter cube 17.

The selected excitation light is diverted in the direction of the sample 20 by the beam splitter 19, which is preferably executed as a partially permeable plate, passing through a lens 21, which focuses it on the sample 20.

The sample 20 is excited to fluorescence. The fluorescent light coming from the sample 20 is bundled by the lens 21 and, after passing through the lens 21, passes through the beam splitter 19 of the filter cube 17.

The receiving surface of the filter cube 17 pointing in the direction of a camera 22 is provided with a second spectral filter 23, which allows only the fluorescent light coming from the sample 20 to pass through it. An imaging tube 24, which images the sample surface onto a locally resolving receiving surface in the camera 22, is disposed between the filter cube 17 and the camera 22. An aperture 25 is normally located upstream from the camera 22.

The exemplary embodiment selected here is described for fluorescence microscopy. This is why the filter cube 17, with regard to its overall function, is executed as a color splitter. If at least one of the spectral filters 18 or 23 is removed and the beam splitter 19 is executed as a non-dichroitic splitter, this microscope arrangement is also suitable for imaging and measuring reflective samples.

The sample 20 is positioned on a sample table 38, which is adjustable in coordinate directions X and Y perpendicular to the optical axis of the lens 21. In this regard, the optical axis of the lens 21 is oriented to be perpendicular to the direction of gravity, while the coordinate direction Y is oriented to be parallel to the direction of gravity.

With this microscope arrangement, the conditions are established for highly accurate measurement, especially of biochips, because the sample section to be examined is illuminated as homogeneously as possible.

According to the invention, the homogeneity of the illumination light is improved even further if, for example, the receiving surface 8 and/or the emitting surface 9 of the homogenization unit 5, as already explained earlier, is provided with a structure comprising microlenses.

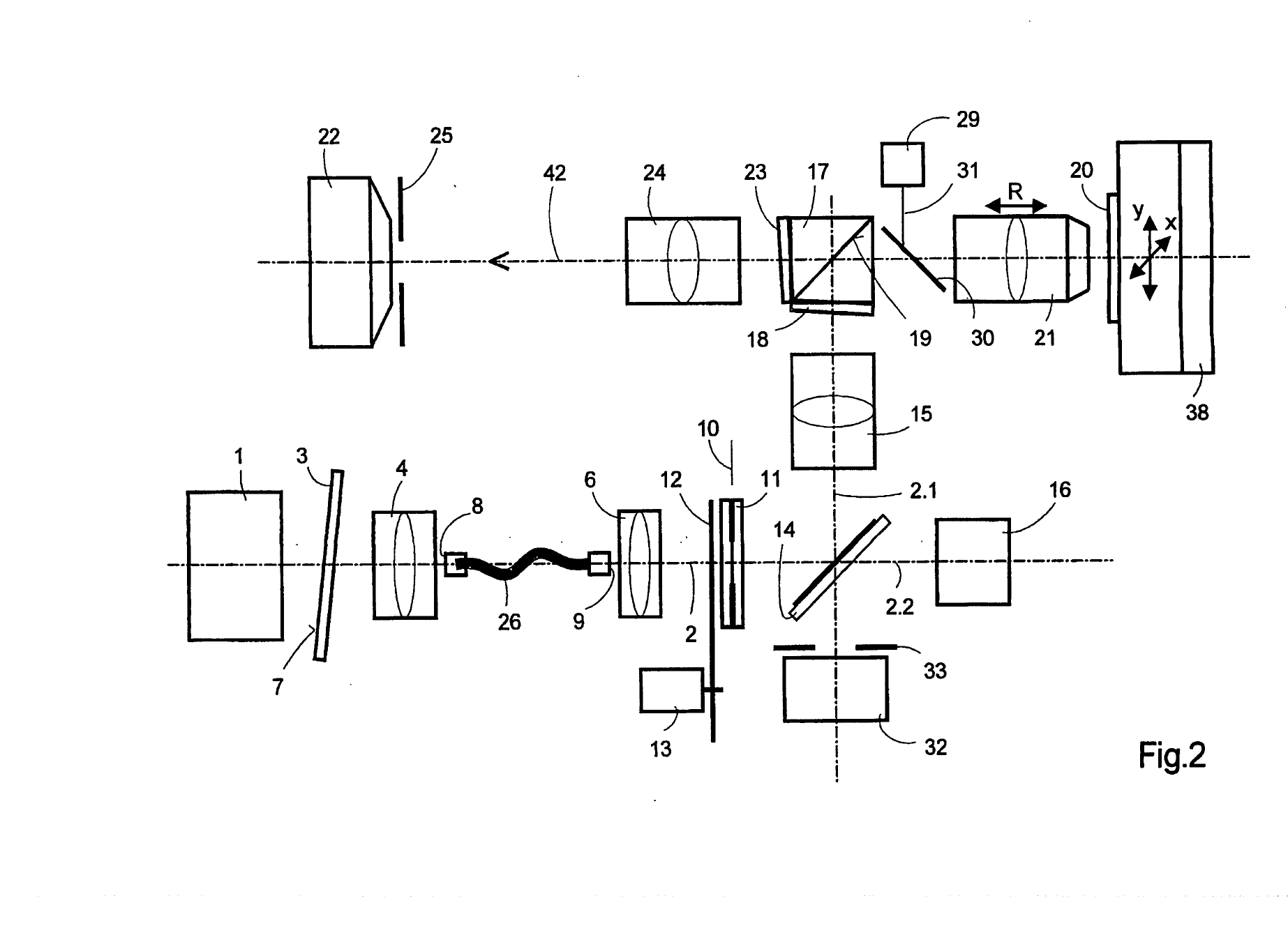

The execution of the homogenization unit 5 as an internally totally reflective, transparent solid rod or as an internally reflective hollow rod, as shown in FIG. 1, is selected for exemplary purposes. In another embodiment, as shown in FIG. 2, the homogenization unit 5 can also be executed flexibly as a bundle of glass fibers 26.

In this case, a receiving surface 8 and a emitting surface 9 can be assigned to the bundle of glass fibers 26 and can also be structured with microlenses, as described above.

In addition to or instead of the emitting surface 9, a light dispersion disk (not shown in the drawing) can be present, further influencing the homogenization of beam intensity.

For reasons of comprehensibility, the same reference symbols have been used in FIG. 1 and FIG. for the same respective components.

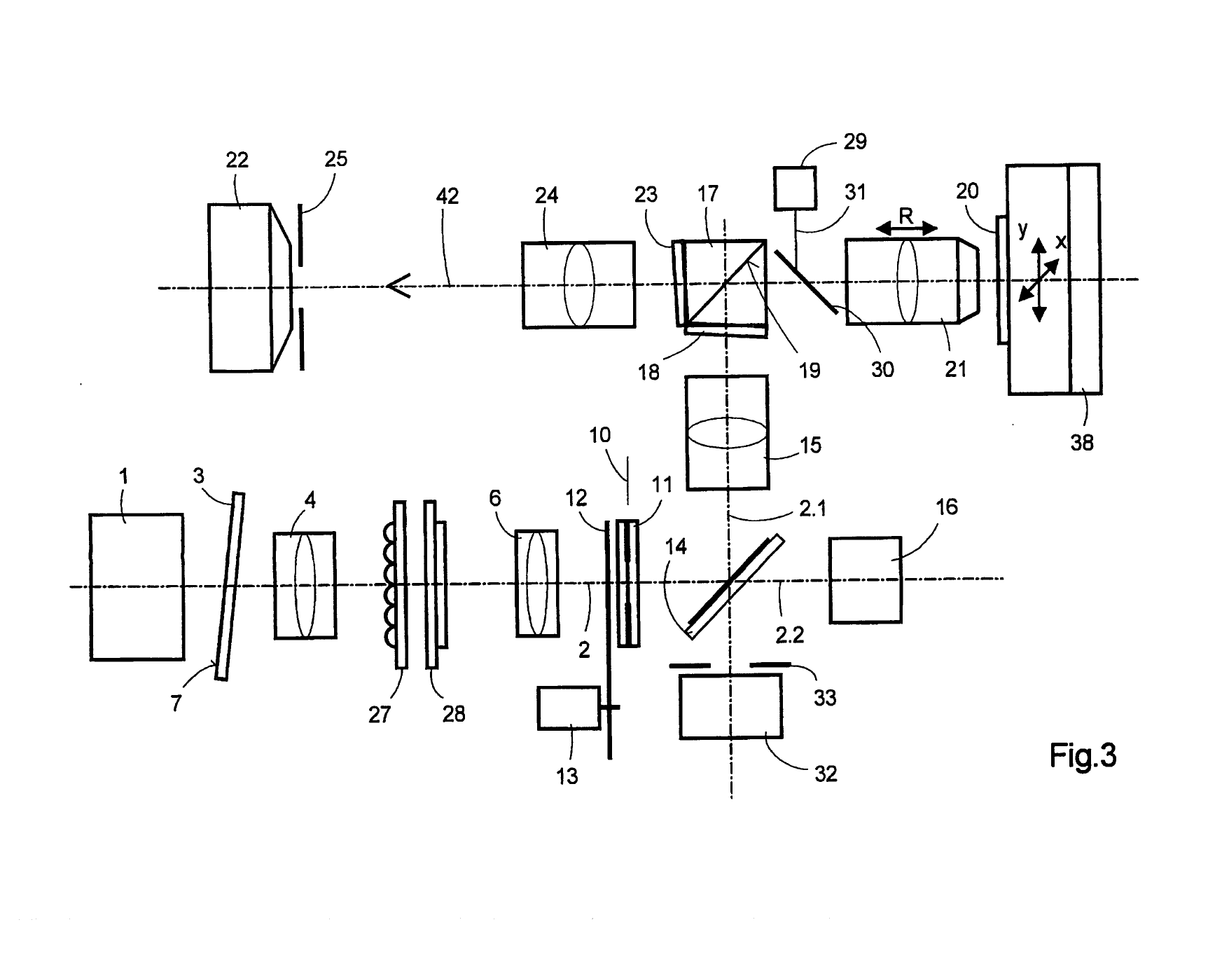

This also applies to FIG. 3, which essentially depicts the same structure of the microscope arrangement as shown in FIG. 1 and FIG. 2, the difference being that in this case the homogenization unit 5 consists of two optical elements 27 and 28, both of which feature a structure consisting of microlenses on their light receiving surface facing the illumination source 1. In both cases, the longitudinal direction of the micro-cylinder lens is oriented to be perpendicular to the optical axis 2 of the illumination beam path, although the longitudinal direction of the micro-cylinder lenses on the optical element 27 is rotated by 90° relative to the longitudinal direction of the micro-cylinder lenses on the optical element 28.

As described earlier, this also results in a homogenization of the intensity of the illumination light, thereby solving the underlying objective of the invention.

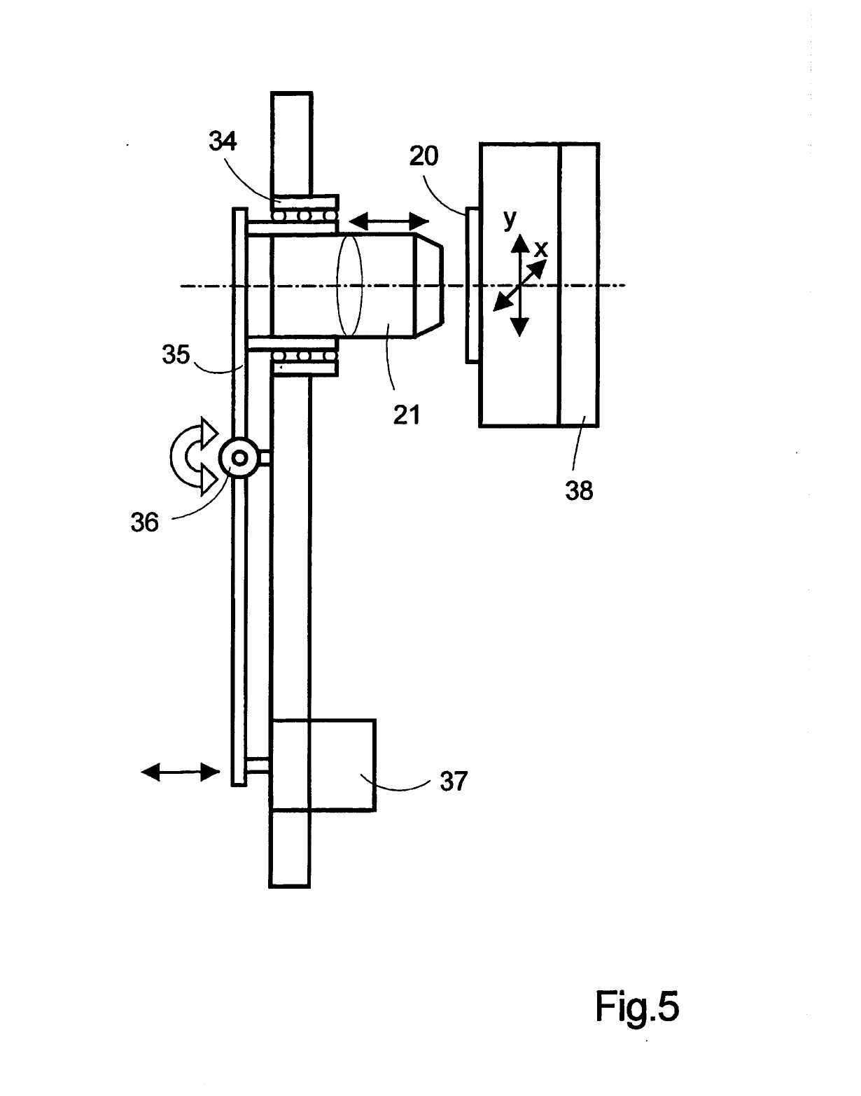

It also follows from FIG. 1, FIG. 2 and FIG. 3 that the microscope arrangement according to the invention is provided with an autofocusing device, which essentially comprises an autofocus laser 29, a glass plate 30 for bunching the laser beam 31 emitted by the autolaser 29 in the illumination beam path, an autofocus actuator, which is described below on the basis of FIG. 5, as well as an autofocus sensor 32.

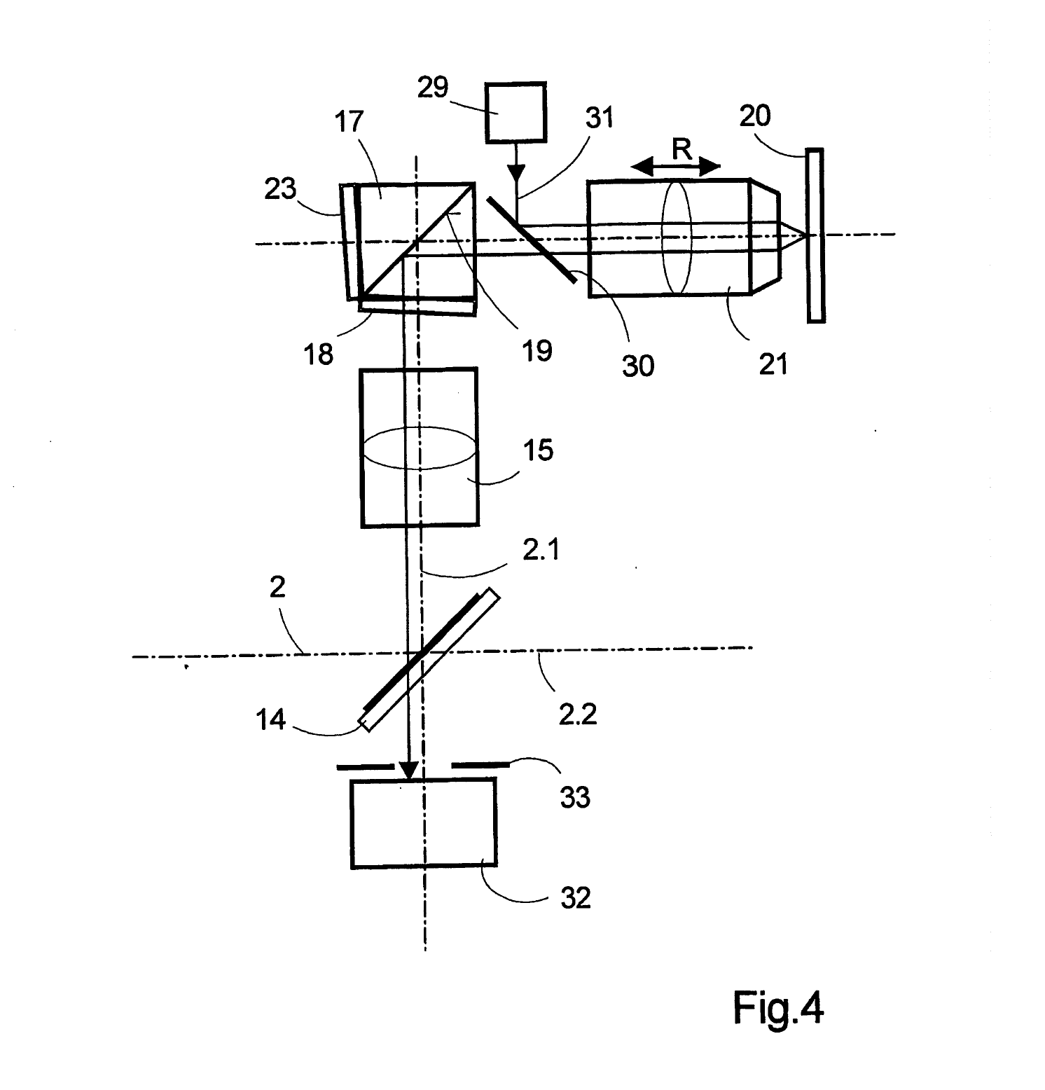

But first the operating principle of the autofocus device will be described in greater detail on the basis of FIG. 4. As is evident in FIG. 4, the glass plate 30, by which the laser beam 31 used for focusing is guided through the lens 21 and onto the sample 20, is disposed between the filter cube 17 and the lens 21. The glass plate 30 is preferably lumenized on the side facing away from the autofocus laser 29. The glass path of the glass plate 30 is taken into account arithmetically in terms of total lens design.

The laser beam 31 is reflected by the surface of the sample 20, passes through the lens 21 again in the opposite direction, passes through the glass plate 30 and is diverted at the beam splitter 19 of the filter cube 17 in the direction of the illumination tube 15, passes through the illumination tube 15 and the partially transparent diversion mirror 14, and then contacts the autofocus sensor 32, which is normally downstream from an aperture 33.

The laser beam 31 possesses a wavelength that is reflected, at least for the most part, by the beam splitter 19 of the filter cube 17. The partially transparent diversion mirror 14 is sufficiently transparent for the wavelength of the laser beam 31, so that a sufficient radiation fraction reaches the autofocus sensor 32. The autofocus sensor 32 contains, for example, a locally resolving receiving surface (Positive Sensitive Detector), a four-quadrant photodiode, a CCD reception line or a two-dimensional CCD receiver.

If the lens 21 is displayed in the displayed direction R, the spatial distribution of the laser beam reflected by the sample surface changes on the receiving surface of the autofocus sensor 32. This is a criterion for the current focus position of the sample 20 relative to the lens 21.

For the purpose of displacement in direction R, the lens 21 is connected with a slide bar 34 oriented in parallel to the optical axis 2 of the illumination beam path, said slide bar having a drive 37 that can be controlled with positional accuracy (see FIG. 5). In this regard, the signal input of the drive is connected with the signal output of the autofocus sensor 32 through an evaluation and control device (which, like the drive, is not shown in the drawing). Because a control circuit to be created for this purpose is sufficiently known in the field of control engineering, it does not require further explanation at this point.

In the interest of completeness, it should be noted that for autofocusing purposes, the illumination beam path can, in principle, also be used instead of the bunched laser beam 31 to determine the focus position.

The principle of the autofocus actuator is depicted in FIG. 5. The purpose of said actuator is to shift the lens 21, as a factor of a setting command, in direction R of the optical axis 2 of the illumination beam path, thereby changing the distance between the sample 20 and the lens 21 in order to bring the focal point of the lens 21 into the desired position relative to the sample 20. The slide bar 34 is depicted symbolically in FIG. 5.

In this regard, the lens is permanently connected with a moveable part of the slide bar 34. The lens 21 is connected with a drive 37, executed here as a linear drive, for example, through a rocker 35, which pivots around a hinge 36. Suitable drive mechanisms, such as motorized spindle drives, piezo-actuators, magnetic core/magnetic coil adjustment devices, etc. can be used as linear drives.

As described further above, the signal output of the autofocus sensor 32 in FIG. 4 is connected with an evaluation and control unit, not shown in the drawing, which generates a control command for the drive 37 as a factor of the focus position currently determined. As a result, the interplay between the autofocus sensor 32 and the drive 37 produces an automatic setting of the optimal focus position, so that the sample 20 is located precisely in the object plane and is sharply reproduced on the receiving surface of the camera 22.

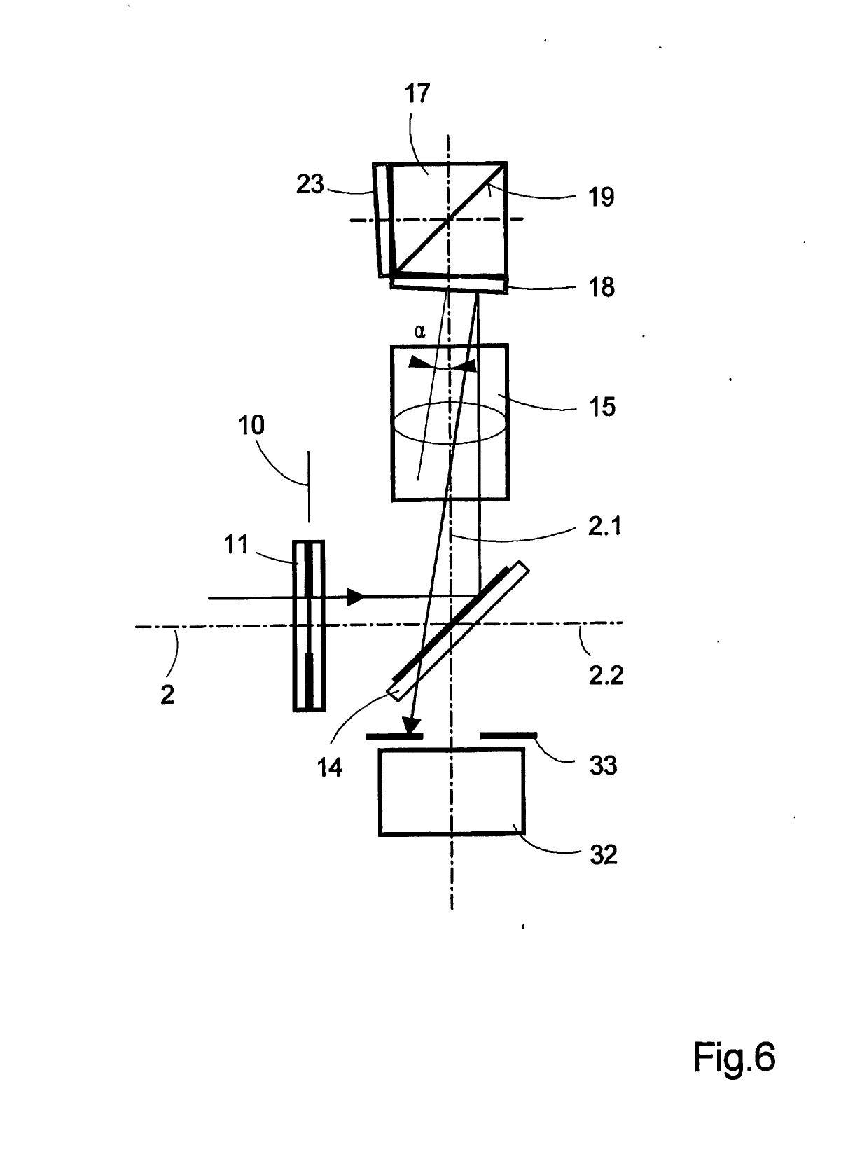

FIG. 6 shows an embodiment variant of the microscope arrangement according to the invention, which is especially advantageous with regard to autofocusing. The drawing indicates that the planar normal of the spectral filter 18 is not oriented in parallel to the optical axis of the illumination tube 15, instead forming an angle α of 5°, for example, with this optical axis.

As a result, the illumination light reflected at the receiving surface does not reach the autofocus sensor 32, thereby avoiding over-saturation of the autofocus sensor 32 by this false light relative to autofocusing.

In an especially preferred embodiment, which is not shown in the drawing, the first spectral filter 18 is disposed on a mount, which allows for modification of the incline of its planar normals and, therefore, manipulation of the light reflected at the first spectral filter 18. During operation of the microscope arrangement, the direction of incline and the angle α are set in such a way that interfering reflexes of the autofocus sensor 32 are minimally disturbing, allowing for optimal determination of the current focus position.

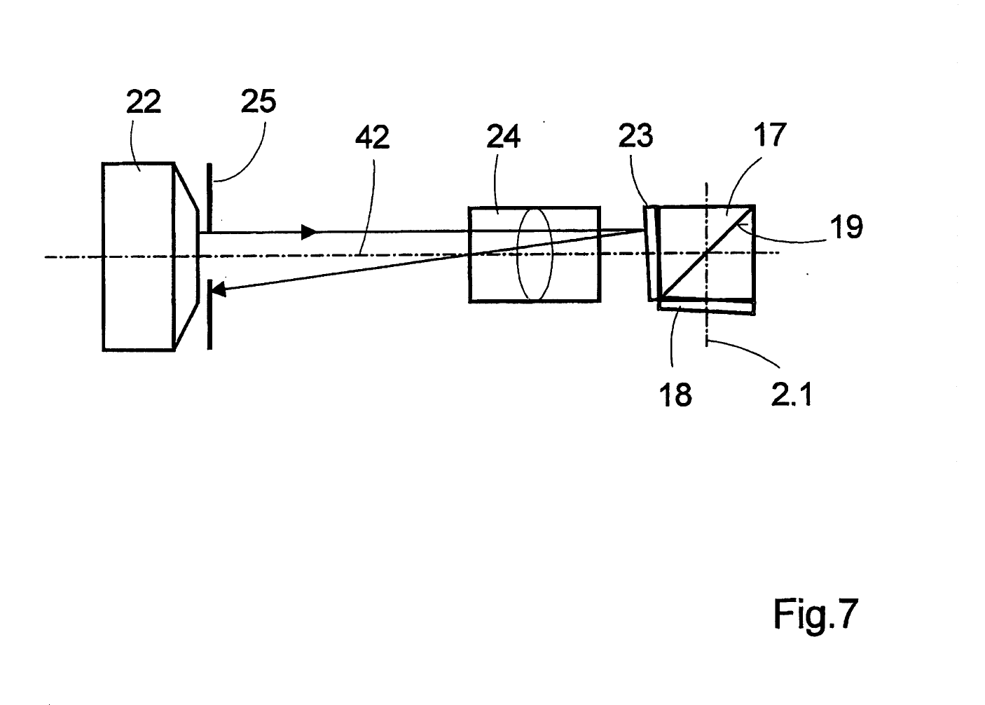

As shown in FIG. 7, it can be provided, in a similar manner, that the planar normal of the second spectral filter 23 and the optical axis 42 of the image beam path enclose an angle within the range of 1° to 20°, preferably 5°. The purpose of tilting the second spectral filter 23 is to prevent the fraction of the imaging light reflected by the receiving surface in the camera 22 from reaching the second spectral filter 23 again and, re-reflected from said filter, from reaching the receiving surface again, which can result in secondary images and/or false images.

As already explained in FIG. 6, on the basis of the first spectral filter 18, the second spectral filter 23 can be disposed on a tilting device, which allows for the adjustment of the angle of slope and the direction of slope, so that, in this case, a setting of the angle of slope can also be found during operation of the microscope arrangement at which interfering reflexes do not falsify or only minimally falsify the reception signal of the camera 22.

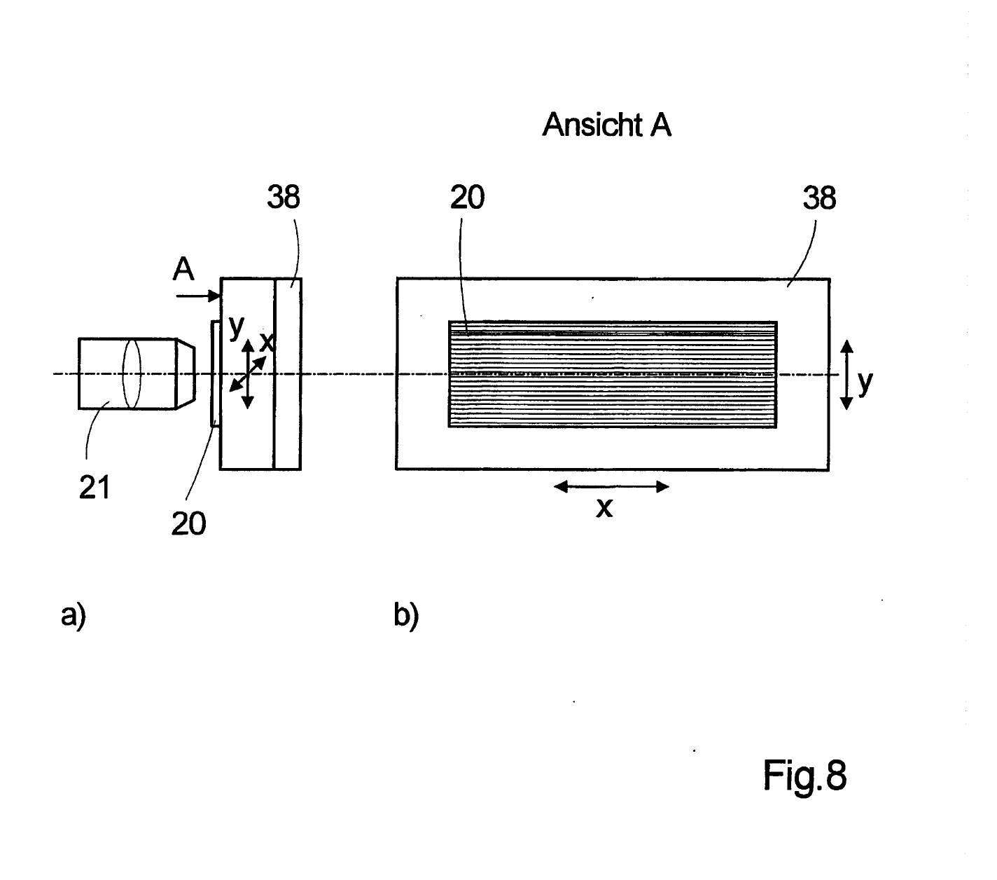

The microscope arrangement according to the invention is also characterized by an especially advantageous drive mechanism, to which the sample table 38 is connected. This is depicted symbolically in FIG. 8.

In FIG. 8a, the sample table 38, which is adjustable in coordinate directions X and Y perpendicular to the optical axis of the lens 21, is disposed, for example, adjacent to the lens 21, whose optical axis is oriented to be perpendicular to the direction of gravity. In this regard, the coordinate direction Y corresponds to the direction of gravity.

FIG. 8b shows a view in direction A (see FIG. 8a), i.e., in the direction of the optical axis, of the sample 20, which, for example, can be mounted in a sample carrier, which is not shown in the figure.

In FIG. 8b, the adjustment directions in coordinates Y and X are illustrated, in which, by means of an adjustment device, a defined position change of the sample table 38 and, therefore, of the sample perpendicular to the optical axis of the lens 21 takes place.

In this regard, it has proven to be effective that the adjustment device has a spindle drive for changing the position of the sample table 38 in coordinate direction Y and a piezo drive for changing the position of the sample table 38 in coordinate direction X. The spindle drive is advantageously connected to a step motor, which, like the piezo drive, permits defined electronic control.

Because the adjustment in coordinate Y occurs in the direction of gravity, the gravitation force acting on the sample table 38 must be offset, for which a spindle drive is advantageously suited. In contrast, the piezo drive selected for adjustment in coordinate X permits relatively rapid linear motion, which, in the selected exemplary embodiment, also accommodates the fact that the sample exhibits greater elongation in the X direction than in the Y direction. Linear piezo drives, which operate on the basis of piezoceramic vibrating rods, are known in the art and therefore require no further explanation here.

The spindle drive and the piezo drive are controlled in such a way that displacement in directions X and Y occurs in steps corresponding to the size of the object field of the lens 21. In this manner, a large number of individual images of the sample surface are obtained, which are stored in evaluation electronics and assembled to form a total image, which can also be done successively after each individual image.

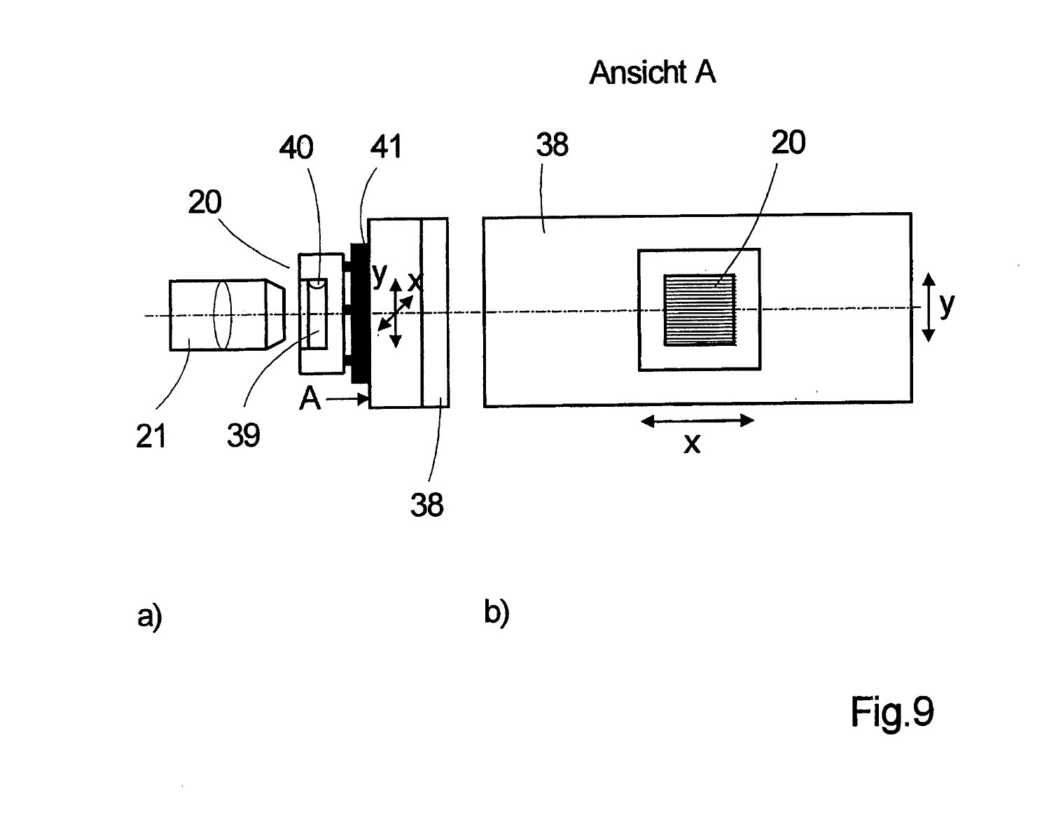

FIG. 9 illustrates how a cartridge-like sample 20, which includes a reservoir for a fluid 39, can be measured with the microscope arrangement according to the invention. In this regard, fluorescent substances, such as fluorescence-marked DNA or proteins, are located at the glass/fluid interface. The focal point of the lens 21 is set precisely on this interface using the autofocusing device.

Because of the horizontal axis of the lens 21, that is, the axis of the lens oriented perpendicular to the direction of gravity, air bubbles that frequently form on glass/fluid interfaces can accumulate at a location 40 above the fluid level.

Because cartridge-like samples 20 often consist of imprecisely manufactured plastic parts, a leveling device 41 is provided, according to the invention, that makes it possible to orient the glass/fluid interface exactly perpendicular to the optical axis of the lens 21, in that the sample surface is tilted against the supporting surface of the sample table 38, thereby orienting the planar normal of the interface to be examined on the sample 20 in parallel to the optical axis of the lens 21.

The invention is especially well-suited for fluorescence-microscopic application. As explained earlier, it can also be easily used for reflective surface examinations.

1-27. (canceled)

28. A microscope arrangement, comprising
an illumination source having optical components for generating an illumination beam path;
a lens through which the illumination beam path is directed onto a sample located in or in proximity of an object plane of the lens;
optical components for generating an imaging beam path directed onto a receiving surface of a camera, and
a homogenizing unit to homogenize the intensity of illumination light that is incident on the sample section to be examined.

29. The microscope arrangement as recited in claim 28, wherein the homogenization unit comprises a fiber-optic waveguide including a receiving surface facing the illumination source and an opposing emitting surface.

30. The microscope arrangement as recited in claim 29, wherein the fiber-optic waveguide comprises an internally reflective hollow rod, a totally internally reflective, transparent solid rod, a liquid fiber-optic waveguide or a bundle of glass fibers.

31. The microscope arrangement as recited in claim 29, wherein the optically active cross-section of the fiber-optic waveguide is formed to be circular, square or rectangular.

32. The microscope arrangement as recited in claim 29, wherein the receiving surface, the emitting surface or both the receiving surface and the emitting surface of the homogenization unit comprises a microlens structure.

33. The microscope arrangement as recited in claim 32, wherein the microlens structure comprises a plurality of round, square, honeycomb-shaped or cylindrical micro-lenses, each having a line radius of approximately 100μm to 1000 μm, disposed adjacent to one another.

34. The microscope arrangement as recited in claim 28, wherein the homogenization unit comprises
first and second optical components including micro-cylinder lenses, arranged in sequence in the illumination beam path, wherein
the axes of the micro-cylinder lenses on the first and second components are oriented to be substantially perpendicular to an optical axis of the illumination beam path; and
wherein the axes of the micro-cylinder lenses of the first component are at substantially right angles to the longitudinal direction of the micro-cylinder lenses of the second component.

35. The microscope arrangement as recited in claim 29, further comprising first imaging optics imaging the emitting surface in a field aperture plane and second imaging optics imaging the field aperture plane in a lens plane.

36. The microscope arrangement as recited in claim 28, further comprising a field aperture having an optically active surface comprising alternate transparent and non-transparent partial surfaces.

37. The microscope arrangement as recited in claim 36, wherein the optically active surface of a field aperture is structured to be a strip pattern or chessboard pattern.

38. The microscope arrangement as recited in claim 36, wherein a controllable shutter for darkening selected surface sections of the field aperture is disposed in front of the field aperture.

39. The microscope arrangement as recited in claim 36, further comprising
a partially permeable diversion mirror disposed downstream from the field aperture in the illumination beam path which diverts a predominant portion of illumination light to be guided through an illumination tube that parallelizes the illumination beam path, and
a first spectral filter for selection of a fraction of the illumination light intended for excitation
a color splitter following the first spectral filter, which guides a predominant portion of illumination light through the lens and onto the sample.

40. The microscope arrangement as recited in claim 39, in which the color splitter comprises a dichroitic mirror, or a partially transparent mirror

41. The microscope arrangement as recited in claim 39, wherein
light emitted by fluorescence of the sample passes back through the lens,
passes through the splitter surface of the color splitter and,
subsequently through a second spectral filter, which transmits the emitted light, and reaches
the camera through an imaging tube.

42. The microscope arrangement as recited in claim 41, characterized in that the illumination tube and the imaging tube are formed from substantially identical optical components.

43. The microscope arrangement as recited in claim 41, in which a removable equalizing glass is disposed in front of the lens, whereby measurements of the sample can be taken with the equalizing glass, on an air/solid object contact surface of the sample facing the lens or, without the equalizing glass, through a transparent sample carrier.

44. The microscope arrangement as recited in claim 28, wherein a fraction of the illumination light passing through the partially transparent diversion mirror is directed onto a monitor detector, which serves to monitor intensity of the illumination light.

45. The microscope arrangement as recited in claim 40, wherein planar normals of the first and second spectral filters and the optical axis of the illumination beam path and the optical axis of the imaging beam path have an angle in the range of about 1 degree to about 20 degrees.

46. The microscope arrangement as recited in claim 45, wherein planar normals of the spectral filters and the optical axis of the illumination beam path and the optical axis of the imaging beam path have an angle of about 5°.

47. The microscope arrangement as recited in claim 40, wherein the first spectral filter in the illumination beam path and the second spectral filter in the emission beam path, together with the color splitter, are structured as a first filter cube.

48. The microscope arrangement as recited in claim 47, wherein the first filter cube is disposed with at least a second filter cube, which differs from the first filter cube with respect to its configuration for the excitation and emission wavelengths of the illumination light, on a changing device,

49. The microscope arrangement as recited in claim 48, wherein the changing device comprises a change wheel.

50. The microscope arrangement as recited in claim 28, wherein a grayscale filter pivots in the illumination beam path against an optical axis of said illumination beam path, wherein a planar normal on an incident light surface of the grayscale filter and the optical axis of the illumination beam path make an angle in the range of about 5° to about 15°.

51. The microscope arrangement as recited in claim 28, wherein the illumination source is connected to the remaining components of the microscope arrangement by a detachable mechanical connection.

52. The microscope arrangement as recited in claim 28, wherein the lens is arranged to be displaceable on a slide bar substantially parallel to its optical axis and is coupled with a motor-driven adjustment device.

53. The microscope arrangement as recited in claim 28, wherein the lens and at least one other lens, which differs from the first lens with respect to its optical properties, are disposed on a changing device.

54. The microscope arrangement as recited in claim 28, wherein the changing device comprises a lens revolver.

55. The microscope arrangement as recited in claim 28, wherein
an autofocusing device is provided that comprises an autofocus laser, an autofocus sensor and an autofocus actuating mechanism, and
an autofocus laser beam bundler in the illumination beam path.

56. The microscope arrangement as recited in claim 28, wherein the camera comprises a CCD or CMOS camera.

57. The microscope arrangement as recited in claim 28, wherein the optical axis of the lens is oriented to be perpendicular to the direction of gravity.

58. The microscope arrangement as recited in claim 28, further comprising a sample table adjustable in coordinate directions X and Y perpendicular to the optical axis of the lens to support a sample, wherein coordinate direction Y is aligned parallel to the direction of gravity.

59. The microscope arrangement as recited in claim 58, wherein the sample table is coupled to a piezo drive and a spindle drive, wherein the piezo drive controls adjustment in coordinate direction X and the spindle drive controls adjustment in coordinate direction Y.

60. The microscope arrangement as recited in claim 59, wherein the sample table is operably connected to a leveling device used to adjust the incline of the sample surface relative to the optical axis of the lens.

61. The microscope arrangement as recited in claim 58, wherein the sample is supported on the sample table by a sample holder, the sample holder and the sample table being detachably connectable to one another.
